(19) United States
(12) Patent Application Publication
(10) Pub. No.: US 2025/0263083 A1
(43) Pub. Date: Aug. 21, 2025

(54) DETECTION OF POTENTIAL ROLLOVER SITUATIONS FOR A VEHICLE

(71) Applicant: Volvo Construction Equipment AB, Eskilstuna (SE)

(72) Inventors: Adithya ARIKERE, Göteborg (SE); Roland KVIST, Braås (SE); Magnus ANDERSSON, Växjö (SE)

(73) Assignee: Volvo Construction Equipment AB, Eskilstuna (SE)

(21) Appl. No.: 19/028,176

(22) Filed: Jan. 17, 2025

(30) Foreign Application Priority Data
Feb. 20, 2024 (EP) 24158738.5

(51) Int. Cl. B60W 40/112; B60W 30/14; B60W 50/14

(52) U.S. Cl. CPC B60W 40/112; B60W 30/146; B60W 50/14; B60W 2300/14; B60W 2520/18

(57) ABSTRACT

A computer-implemented method is disclosed for detecting potential rollover situations for a vehicle. The method comprises acquiring lateral and vertical wheel forces for the vehicle, and detecting potential rollover based on the lateral and vertical wheel forces as compared between first and second lateral sides of the vehicle. Potential rollover may be detected responsive to the lateral wheel forces being larger for the first lateral side of the vehicle than for the second lateral side of the vehicle, and correspondingly for the vertical wheel forces. Potential rollover may be detected responsive to a sum of the lateral and vertical wheel forces for the first lateral side of the vehicle exceeding a threshold value.

### TECHNICAL FIELD

The disclosure relates generally to vehicle control. In particular aspects, the disclosure relates to detection of potential rollover situations for a vehicle. The disclosure can be applied to heavy-duty vehicles, such as trucks, buses, and construction equipment, among other vehicle types. The suggested approaches may be particularly suitable for vehicles, such as articulated haulers, with a joint that allows free rolling around the longitudinal axis of the vehicle. Although the disclosure may be described with respect to a particular vehicle, the disclosure is not restricted to any particular vehicle.

### BACKGROUND

Rollover accidents are typically very expensive. For example, they may cause irreversible damage to the vehicle.

Therefore, there is a need for approaches of mitigation of rollover (e.g., avoiding rollover, decreasing the probability of rollover, etc.).

### SUMMARY

Various aspects may aim to solve, mitigate, alleviate, or eliminate at least some of the above or other disadvantages.

According to a first aspect of the disclosure, a computer system is provided for detecting potential rollover situations for a vehicle comprising one or more vehicle units. The computer system comprises processing circuitry configured to acquire lateral and vertical wheel forces for one of the vehicle units, and detect potential rollover for the vehicle unit based on the lateral and vertical wheel forces as compared between first and second lateral sides of the vehicle unit. The first aspect of the disclosure may seek to provide an arrangement configured to enable vehicle rollover mitigation.

A technical benefit may include that upcoming and/or current situations in which rollover is certain or likely to occur can be detected. The detection may be improved compared to other approaches for rollover detection. For example, the detection may be more reliable, and/or more robust, and/or more accurate than for other approaches for rollover detection. Alternatively or additionally, the probability of missed detection, and/or the probability of false detection, may be may be decreased compared to other approaches for rollover detection. Yet alternatively or additionally, earlier detection may be achieved than for other approaches for rollover detection.

Additionally or alternatively, a technical benefit may include that already measured and/or calculated force values may be used for the purpose of rollover detection. For example, force values determined based on measurements by wheel mounted inertial measurement units (IMUs) and/or force values predicted based on actuator request may be used for the rollover detection.

According to a second aspect of the disclosure, a computer-implemented method is provided for detecting potential rollover situations for a vehicle comprising one or more vehicle units. The method comprises acquiring (by a processor device of a computer system) lateral and vertical wheel forces for one of the vehicle units, and detecting (by the processor device) potential rollover for the vehicle unit based on the lateral and vertical wheel forces as compared between first and second lateral sides of the vehicle unit. The second aspect of the disclosure may seek to enable vehicle rollover mitigation.

A technical benefit may include that upcoming and/or current situations in which rollover is certain or likely to occur can be detected. The detection may be improved compared to other approaches for rollover detection. For example, the detection may be more reliable, and/or more robust, and/or more accurate than for other approaches for rollover detection. Alternatively or additionally, the probability of missed detection, and/or the probability of false detection, may be may be decreased compared to other approaches for rollover detection. Yet alternatively or additionally, earlier detection may be achieved than for other approaches for rollover detection.

Additionally or alternatively, a technical benefit may include that already measured and/or calculated force values may be used for the purpose of rollover detection. For example, force values determined based on measurements by wheel mounted inertial measurement units (IMUs) and/or force values predicted based on actuator request may be used for the rollover detection.

Optionally in some examples, including in at least one preferred example, potential rollover may be detected responsive to the lateral wheel forces being larger for the first lateral side of the vehicle unit than for the second lateral side of the vehicle unit, and the vertical wheel forces being larger for the first lateral side of the vehicle unit than for the second lateral side of the vehicle unit. A technical benefit may include improved detection compared to other approaches for rollover detection.

Optionally in some examples, including in at least one preferred example, potential rollover may be detected responsive to a sum of the lateral and vertical wheel forces for the first lateral side of the vehicle unit exceeding a threshold value for the sum. A technical benefit may include improved detection compared to other approaches for rollover detection.

Optionally in some examples, including in at least one preferred example, potential rollover may be detected responsive to a derivative—with regard to time—of the sum of the lateral and vertical wheel forces for the first lateral side of the vehicle unit exceeding a threshold value for the derivative. A technical benefit may include improved detection compared to other approaches for rollover detection.

Optionally in some examples, including in at least one preferred example, potential rollover may be detected responsive to the lateral and/or vertical wheel forces for the second lateral side of the vehicle unit being less than respective threshold value(s) for the second lateral side. A technical benefit may include improved detection compared to other approaches for rollover detection.

Optionally in some examples, including in at least one preferred example, detecting potential rollover for the vehicle unit may be further based on a roll angle for the vehicle unit. A technical benefit may include further improved detection compared to other approaches for rollover detection. Additionally or alternatively, a technical benefit may include that already measured and/or calculated rollover angle values may be used for the purpose of rollover detection. For example, rollover angle values determined based on measurements by a centralized inertial measurement unit (IMU) and/or rollover angle values predicted based on a global request of forces and/or moments may be used for the rollover detection.

Optionally in some examples, including in at least one preferred example, potential rollover may be detected responsive to the roll angle exceeding a threshold value for the roll angle. A technical benefit may include further improved detection compared to other approaches for rollover detection.

Optionally in some examples, including in at least one preferred example, the vehicle comprises at least two vehicle units, and potential rollover may be detected responsive to a difference between the roll angle and another roll angle of another one of the at least two vehicle units exceeding a threshold value for the difference. A technical benefit may include further improved detection compared to other approaches for rollover detection.

Optionally in some examples, including in at least one preferred example, potential rollover may be detected responsive to a derivative—with regard to the roll angle—of a roll moment of the vehicle unit having a negative value and the roll moment multiplied by a sign of the roll angle exceeding a threshold value for the roll moment. A technical benefit may include further improved detection compared to other approaches for rollover detection.

Optionally in some examples, including in at least one preferred example, the method may further comprise—responsive to detecting potential rollover for the vehicle unit—issuing (by the processor device) a warning for an operator of the vehicle, and/or limiting (by the processor device) a speed of the vehicle. A technical benefit may include the vehicle rollover mitigation is achieved. Thereby, the probability of rollover accidents may be decreased.

According to a third aspect of the disclosure, a vehicle is provided that comprises the computer system of the first aspect and/or a processor device configured to perform the method of the second aspect. The third aspect of the disclosure may seek to provide a vehicle which has a relatively low probability of rollover accidents. A technical benefit may include that efficient rollover mitigation is enabled for the vehicle.

According to a fourth aspect of the disclosure, a control system is provided comprising one or more control units configured to perform the method of the second aspect.

According to a fifth aspect of the disclosure, a computer program product is provided, which comprises program code for performing, when executed by the processing circuitry, the method of the second aspect. The fifth aspect of the disclosure may seek to convey program code for rollover detection. A technical benefit may include that new vehicles and/or legacy vehicles may be conveniently configured, by software installation/update, to acquire lateral and vertical wheel forces for a vehicle unit, and detect potential rollover for the vehicle unit based on the lateral and vertical wheel forces as compared between first and second lateral sides of the vehicle unit.

According to a sixth aspect of the disclosure, a non-transitory computer-readable storage medium is provided. The non-transitory computer-readable storage medium comprises instructions, which when executed by the processing circuitry, cause the processing circuitry to perform the method the second aspect. The sixth aspect of the disclosure may seek to convey program code for rollover detection. A technical benefit may include that new vehicles and/or legacy vehicles may be conveniently configured, by software installation/update, to acquire lateral and vertical wheel forces for a vehicle unit, and detect potential rollover for the vehicle unit based on the lateral and vertical wheel forces as compared between first and second lateral sides of the vehicle unit.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a flowchart illustrating a method according to some examples.

FIG. 2 is a schematic drawing illustrating a side view of a vehicle according to some examples.

FIG. 3 is a schematic drawing illustrating a top view of a vehicle according to some examples.

FIG. 4 is a pair of schematic diagrams illustrating lateral and longitudinal forces according acting on a vehicle according to some examples.

FIG. 5 is a flowchart illustrating method steps according to some examples.

FIG. 6 is a schematic diagram illustrating a computer system for implementing examples disclosed herein, according to some examples.

FIG. 7 is a schematic drawing illustrating a computer program product, in the form of a non-transitory computer-readable storage medium, according to some examples.

FIG. 8 is a schematic block diagram of a control unit according to some examples.

### DETAILED DESCRIPTION

The detailed description set forth below provides information and examples of the disclosed technology with sufficient detail to enable those skilled in the art to practice the disclosure.

As already mentioned, it is generally desired to mitigate rollover accidents (e.g., avoid rollover accidents, or at least decrease the probability of rollover accidents). To this end, it may be preferable to have an approach for detecting upcoming and/or current situations in which rollover is certain or likely to occur.

It may be desirable to have early detection of potential rollover situations. Alternatively or additionally, it may be desirable to have reliable detection (e.g., as few false detections as possible and/or as few missed detections as possible).

Generally, it should be noted that approaches suggested herein may be applied to any suitable vehicle or vehicle combination, as suitable. For example, approaches suggested herein may be applied to heavy-duty vehicles (e.g., trucks, buses, construction equipment, etc.). The suggested approaches may be particularly suitable for vehicles with a joint that allows free rolling around the longitudinal axis of the vehicle (e.g., articulated haulers).

Also generally, it should be noted that rollover may refer to rollover of an entire vehicle, or to rollover of only one vehicle unit. For example, for vehicles with a joint that allows free rolling around the longitudinal axis of the vehicle, a rollover accident may include that the trailer unit rolls over while the tractor unit does not, or vice versa. Alternatively or additionally, for any vehicle with a tractor and a trailer unit, rollover by the trailer unit may cause the tractor unit to subsequently rollover as well.

Also generally, it should be noted that approaches suggested herein may be applied to any suitable terrain scenarios (e.g., flat or uneven, with obstacles, with varying slope, with varying banking, etc.).

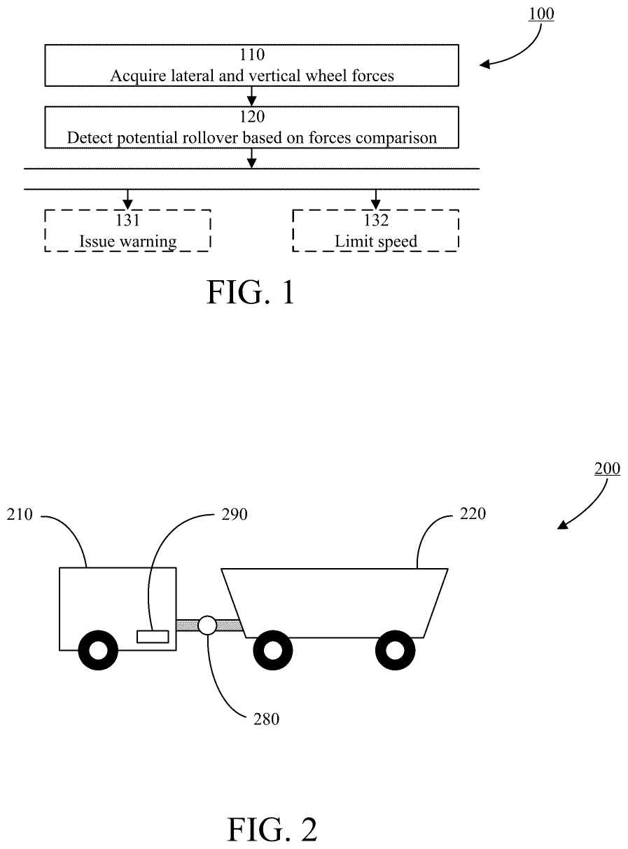

FIG. 1 illustrates a method 100 for detecting potential rollover situations for a vehicle comprising one or more (e.g., two) vehicle units. The method 100 is a computer-implemented method. For example, the method 100 may be executed by a processor device of a computer system.

As illustrated by step 110, the method 100 comprises acquiring lateral and vertical wheel forces for at least one (e.g., one, two, some, or all) of the vehicle units. The lateral and vertical wheel forces may be acquired for all wheels of the vehicle unit, or for only some wheels of the vehicle unit. The lateral and vertical wheel forces may be acquired in any suitable way.

According to some examples, measurements by wheel mounted (e.g., mounted within tire) accelerometers (e.g., IMUs) may be used to determine the lateral and/or vertical wheel forces. For example, the amplitude of an acceleration spike experienced when the accelerometer passes the contact patch between tire and ground may be used to estimate the lateral and/or vertical wheel forces. This approach for acquiring the lateral and vertical wheel forces is best suited for a vehicle in motion.

According to some examples, measurements by other sensors may be used (additionally or alternatively to wheel mounted accelerometers) to determine the lateral and/or vertical wheel forces. For example, a tire pressure sensor may be used to estimate the vertical force of a wheel (at standstill or in motion). Alternatively or additionally, any sensor associated with the suspension of a wheel (e.g., a load sensor, a pressure sensor, etc.) may be used to estimate the vertical force of a wheel (at standstill or in motion).

As illustrated by step 120, the method 100 comprises detecting potential rollover for the vehicle unit based on the lateral and vertical wheel forces as compared between first and second lateral sides of the vehicle unit. The potential rollover could relate to the vehicle unit only (e.g., for a trailer unit of an articulated hauler), or to the entire vehicle.

As illustrated by optional steps 131 and 132, the method 100 may further comprise—as a response to detecting potential rollover for the vehicle unit—issuing a warning for an operator of the vehicle, and/or limiting a speed of the vehicle (e.g., decreasing the speed, hindering the speed from increasing, etc.).

It should be noted that (additionally or alternatively) other rollover mitigation actions may be performed responsive to the detection of potential rollover. For example, the detection may be forwarded to a vehicle control unit which may be configured to vary other aspect of the vehicle than speed (e.g., acceleration, load distribution, brake distribution, etc.). One example mitigation action could include releasing rear brakes and applying high brake forces at the front of the vehicle to cause the vehicle to slowly roll backwards to escape a situation with rollover risk.

According to some examples, two or more levels of rollover risk are applied, where each level corresponds to a respective condition for detection (possibly a combination of conditions for detection) and is associated with a respective mitigation action (or combination of mitigation actions). For example a detection associated with a relatively low likelihood for rollover may trigger a warning for an operator of the vehicle, a detection associated with a medium likelihood for rollover may trigger hindering of the speed from increasing (possibly in combination with a warning), and a detection associated with a relatively high likelihood for rollover may trigger decrease of the speed (possibly in combination with a warning). It should be noted that numerous other examples may be envisioned (e.g., different number of levels, different respective conditions, different respective mitigation actions, etc.).

In some examples, the detection of potential rollover may be used to build and/or update a map over some specific geographical area (e.g., a construction site), where the detection of potential rollover is associated with a corresponding location (e.g., acquired using a positioning system, such as the Global Positioning System—GPS) and corresponding information regarding the vertical and lateral forces. Geographical information (e.g., ground slope, friction, etc.) and/or infrastructure information (e.g., course of driveways, obstacles, etc.) could also be used to strengthen the benefits of the map.

The map may be used for proactive vehicle control within the specific geographical area. For example, the operator of the vehicle may be proactively warned when locations where potential rollover is likely are approached. Alternatively or additionally, the speed may be proactively limited when locations where potential rollover is likely are approached.

The information regarding the vertical and lateral forces may be used to selectively perform proactive actions when a location of potential rollover is approached only for vehicles with similar (or otherwise relevant) force values as those relating to the previously detected potential rollover(s).

The detection of potential rollover based on the lateral and vertical wheel forces as compared between first and second lateral sides of the vehicle may be implemented in any suitable way.

In some examples, potential rollover is detected responsive to the lateral wheel forces being larger for the first lateral side of the vehicle unit than for the second lateral side of the vehicle unit, and the vertical wheel forces being larger for the first lateral side of the vehicle unit than for the second lateral side of the vehicle unit.

The condition relating to the lateral and vertical wheel forces as compared between first and second lateral sides of the vehicle may be supplemented by one or more other conditions for detection of potential rollover, and a few examples will be given in the following while it should be noted that other possibilities are not excluded.

In some examples, a supplemental condition for detection of potential rollover is that a sum of the lateral and vertical wheel forces for the first lateral side of the vehicle unit exceeds a threshold value for the sum.

In some examples, a supplemental condition for detection of potential rollover is that a derivative (with regard to time) of the sum of the lateral and vertical wheel forces for the first lateral side of the vehicle unit exceeds a threshold value for the derivative.

In some examples, a supplemental condition for detection of potential rollover is that the lateral and/or vertical wheel forces for the second lateral side of the vehicle unit are less than respective threshold value(s) for the second lateral side.

The condition(s) relating to the lateral and vertical wheel forces may be supplemented by one or more other conditions for detection of potential rollover, and a few examples will be given in the following of supplemental conditions for detection of potential rollover based on a roll angle while it should be noted that other possibilities are not excluded.

In some examples, a supplemental condition for detection of potential rollover is that the roll angle exceeds a threshold value for the roll angle.

In some examples, a supplemental condition for detection of potential rollover when the vehicle comprises at least two vehicle units is that a difference between the roll angles of different vehicle units exceeds a threshold value for the difference.

In some examples, a supplemental condition for detection of potential rollover is that a derivative (with regard to the roll angle) of a roll moment of the vehicle unit has a negative value and the roll moment multiplied by a sign of the roll angle exceeds a threshold value for the roll moment.

The roll angle of a vehicle unit may be acquired in any suitable way. For example, measurements by a centralized IMU of the vehicle unit may be used to estimate the roll angle.

The roll moment of a vehicle unit may be acquired in any suitable way. For example, the roll moment can be derived from the vertical and lateral forces, together with the position of the roll center.

It should also be noted that any suitable combination of the above or other example conditions may be used.

Any one or more of the thresholds mentioned above may be static or dynamically variable. Any suitable parameter(s) (e.g., vehicle speed, vehicle load, steering wheel angle, ground bank angle, friction coefficient, etc.) could be used to dynamically set the threshold value(s). For example, the threshold(s) may be set to stricter value(s) (i.e., earlier detection) when the vehicle speed is high than when it is low. Alternatively or additionally, the threshold(s) may be set to stricter value(s) (i.e., earlier detection) when the vehicle is loaded than when it is un-loaded. Yet alternatively or additionally, the threshold(s) may be set to stricter value(s) (i.e., earlier detection) when the steering angle is relatively far from zero than when it is relatively close to zero. Yet alternatively or additionally, the threshold(s) may be set to stricter value(s) (i.e., earlier detection) when the bank angle is relatively far from zero than when it is relatively close to zero. Yet alternatively or additionally, the threshold(s) may be set to stricter value(s) (i.e., earlier detection) when the friction is relatively low than when it is relatively high.

FIG. 2 schematically illustrates a side view of an example vehicle 200 where the techniques disclosed herein can be advantageously applied. The vehicle 200 comprises a pull/tractor/towing unit 210 configured to tow one or more hauler/trailer unit(s) 220 in a known manner. The vehicle 200 has a joint 280 between the units 210, 220 that allows free rolling around the longitudinal axis of the vehicle. For example, the vehicle 200 may be an articulated hauler.

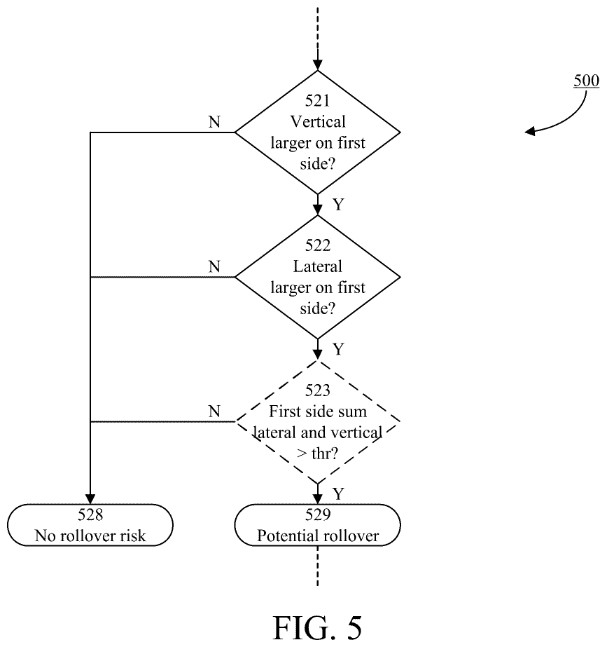

The tractor unit 210 and/or the trailer unit(s) 220 may comprise a vehicle control unit (VCU) 290 configured to perform various vehicle (unit) control functions, such as vehicle motion management (VMM). For example, any of one or more VCU(s) 290 may be configured to perform one or more steps as exemplified in connection with FIG. 1 and/or FIG. 5. Thus, the techniques disclosed herein may be performed by any of one or more VCU(s) 290.

The vehicle 200 further comprises device(s) (e.g., wheel mounted IMUs) configured to provide indications of lateral and vertical wheel forces for at least some of the wheels, and (optionally) device(s) (e.g., a central IMU) configured to provide indications of roll angle for at least one of the vehicle units 210, 220.

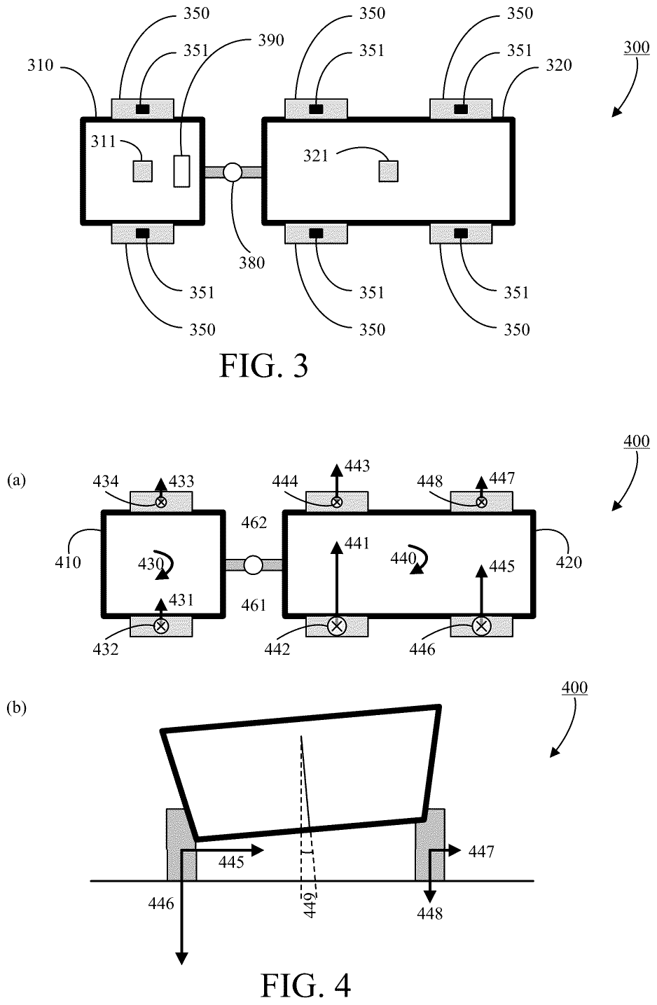

FIG. 3 schematically illustrates a top view of an example vehicle 300 where the techniques disclosed herein can be advantageously applied. For example, the vehicle 300 may correspond to the vehicle 200 of FIG. 2. The vehicle 300 comprises a pull/tractor/towing unit 310 configured to tow one or more hauler/trailer unit(s) 320 in a known manner. The vehicle 300 has a joint 380 between the units 310, 320 that allows free rolling around the longitudinal axis of the vehicle. For example, the vehicle 300 may be an articulated hauler.

The tractor unit 310 and/or the trailer unit(s) 320 may comprise a vehicle control unit (VCU) 390 configured to perform various vehicle (unit) control functions, such as vehicle motion management (VMM). For example, any of one or more VCU(s) 390 may be configured to perform one or more steps as exemplified in connection with FIG. 1 and/or FIG. 5. Thus, the techniques disclosed herein may be performed by any of one or more VCU(s) 390.

The vehicle 300 further comprises devices 351 (e.g., wheel mounted IMUs) configured to provide indications of lateral and vertical wheel forces for at least some of the wheels 350, and devices 311, 321 (e.g., central IMUs) configured to provide indications of roll angles for the vehicle units 310, 320. The devices 351, 311, 321 may be operatively connected to the VCU 390, and may be configured to provide information (from which the lateral and vertical wheel forces and the roll angles can be acquired) to the VCU 390.

FIG. 4 schematically illustrates a top view (a) and a rear view (b) of an example vehicle 400 where the techniques disclosed herein can be advantageously applied. For example, the vehicle 400 may correspond to the vehicle 200 of FIG. 2 and/or to the vehicle 300 of FIG. 3. The vehicle 400 comprises a pull/tractor/towing unit 410 configured to tow one or more hauler/trailer unit(s) 420 in a known manner. The vehicle 400 has a joint between the units 410, 420 that allows free rolling around the longitudinal axis of the vehicle. For example, the vehicle 400 may be an articulated hauler.

FIG. 4 schematically illustrates example lateral and longitudinal forces acting on the vehicle 400; namely lateral wheel forces F_{y1}, F_{y2} 431, 433 and vertical wheel forces F_{z1}, F_{z2} 432, 434 for the pull unit 410, and lateral wheel forces F_{y3}, F_{y4}, F_{y5}, F_{y6} 441, 443, 445, 447 and vertical wheel forces F_{z3}, F_{z4}, F_{z5}, F_{z6} 442, 444, 446, 448 for the hauler unit 420.

FIG. 4 also schematically illustrates example moments acting on the vehicle 400 and an example roll angle; namely moments M_{xP}, M_{yP}, M_{zP}, for the pull unit 410 (schematically shown as 430), moments M_{xH}, M_{yH}, M_{zH} for the hauler unit 420 (schematically shown as 440), and roll angle α_{H} 449 for the hauler unit 420. A roll angle αₚ for the pull unit 410 may also be relevant even if not shown in FIG. 4.

The principles of step 120 of the method 100 of FIG. 1 will now be exemplified with reference to the example vehicle 400.

As already explained, step 120 of the method 100 comprises detecting potential rollover for the vehicle based on the lateral and vertical wheel forces as compared between first and second lateral sides of the vehicle. Thus, potential rollover may be detected for the vehicle 400 by any suitable comparison between one or more of the wheel forces 431, 432, 441, 442, 445, 446 on a first side 461 of the vehicle 400 and one or more of the wheel forces 433, 434, 443, 444, 447, 448 on a second side 462 of the vehicle 400.

It should be noted that the potential rollover could relate to the entire vehicle 400 or to only one of the vehicle units 410, 420.

It should also be noted that—generally—wheel forces may be acquired for all wheels of the vehicle, or for only some of the wheels as possible/suitable.

Also generally, it should be noted that the comparison of forces between first and second lateral sides of the vehicle may comprise any suitable selection of the acquired forces. For example, forces of a single wheel axle could be compared, or all forces of a vehicle unit could be compared, or all forces of a vehicle could be compared. Further, the selection of lateral forces to compare may be different from the selection of vertical forces to compare.

In some examples, potential rollover is detected responsive to the lateral wheel forces being larger for the first lateral side of the vehicle than for the second lateral side of the vehicle, and the vertical wheel forces being larger for the first lateral side of the vehicle than for the second lateral side of the vehicle. This condition aims to indicate that the first side not only carries higher vertical load than the second side, but also higher lateral load. For example, if the vehicle 400 goes into a curve turning to the right, there will be an increase of vertical and lateral forces on the outer side tires (i.e., left side of vehicle) compared to the inner side tires (i.e., left side of vehicle), as exemplified in FIG. 4. Thereby, false detections of potential rollover that could occur due to uneven terrain and/or uneven load if only vertical load was considered, might be avoided.

For the pull unit 410, this condition may be expressed as (F_{y1}>F_{y2} and F_{z1}>F_{z2}). For the hauler unit 420, this condition may, for example, be expressed as (F_{y3}>F_{y4} and F_{z3}>F_{z4}) or as (F_{y5}>F_{y6} and F_{z5}>F_{z6}) or as (F_{y3}>F_{y4} and F_{z3}>F_{z4} and F_{y5}>F_{y6} and F_{z5}>F_{z6}) or as (F_{y3}+F_{y5}>F_{y4}+F_{y6} and F_{z3}+F_{z5}>F_{z4}+F_{z6}). For the entire vehicle 400, this condition may, for example, be expressed as (F_{y1}+F_{y3}+F_{y5}>F_{y2}+F_{y4}+F_{y6} and F_{z1}+F_{z3}+F_{z5}>F_{z2}+F_{z4}+F_{z6}).

The condition relating to the lateral and vertical wheel forces as compared between first and second lateral sides of the vehicle may be supplemented by one or more other conditions for detection of potential rollover, as will be exemplified in the following with reference to the example vehicle 400.

In some examples, a supplemental condition for detection of potential rollover is that a sum of the lateral and vertical wheel forces for the first lateral side of the vehicle exceeds a threshold value for the sum. This condition aims to indicate that the first side carries a relatively high total load (vertical plus lateral). Thereby, more accurate detections of potential rollover might be achieved (e.g., avoiding false positives and/or missed detections).

For the pull unit 410, this condition may be expressed as (F_{y1}+F_{z1}>thr_{sum,pull}). For the hauler unit 420, this condition may, for example, be expressed as (F_{y3}+F_{y5}+F_{z3}+F_{z5}>thr_{sum,haul}). For the entire vehicle 400, this condition may, for example, be expressed as (F_{y1}+F_{y3}+F_{y5}+F_{z1}+F_{z3}+F_{z5}>thr_{sum,veh}).

In some examples, a supplemental condition for detection of potential rollover is that a derivative (with regard to time) of the sum of the lateral and vertical wheel forces for the first lateral side of the vehicle exceeds a threshold value for the derivative. This condition aims to indicate that the total load (vertical plus lateral) carried by the first side increases relatively quickly. Thereby, more accurate detections of potential rollover might be achieved (e.g., avoiding false positives and/or missed detections).

For the pull unit 410, this condition may be expressed as

$$( \frac{δ}{δ t} ( {F}_{y 1} + {F}_{z 1} ) > {thr}_{der , pull} ) .$$

For the hauler unit 420, this condition may, for example, be expressed as

$$( \frac{δ}{δ t} ( {F}_{y 3} + {F}_{y 5} + {F}_{z 3} + {F}_{z 5} ) > {thr}_{der , haul} ) .$$

For the entire vehicle 400, this condition may, for example, be expressed as

$$( \frac{δ}{δ t} ( {F}_{y 1} + {F}_{y 3} + {F}_{y 5} + {F}_{z 1} + {F}_{z 3} + {F}_{z 5} ) > {thr}_{der , veh} ) .$$

In some examples, a supplemental condition for detection of potential rollover is that the lateral and/or vertical wheel forces for the second lateral side of the vehicle are less than respective threshold value(s) for the second lateral side. This condition aims to indicate that the total load (vertical plus lateral) or either the vertical or lateral load carried by the second side is relatively low (e.g., close to zero). For example, this condition could indicate situations where the wheel(s) of the second side of the vehicle is/are close to losing contact with the ground. Thereby, more accurate detections of potential rollover might be achieved (e.g., avoiding false positives and/or missed detections).

For the pull unit 410, this condition may be expressed as (F_{y2}+F_{z2}<thr_{2nd,pull}) or as (F_{y2}<thr_{2nd,pull}) or as (F_{z2}<thr_{2nd,pull}). For the hauler unit 420, this condition may, for example, be expressed as (F_{y4}+F_{y6}+F_{z4}+F_{z6}>thr_{2nd,haul}) or as (F_{y4}+F_{y6}+>thr_{2nd,haul}) or as (F_{z4}+F_{z6}>thr_{2nd,haul}). For the entire vehicle 400, this condition may, for example, be expressed as (F_{y2}+F_{y4}+F_{y6}+F_{z2}+F_{z4}+F_{z6}>thr_{2nd,veh}) or as (F_{y2}+F_{y4}+F_{y6}>thr_{2nd,veh}) or as (F_{z2}+F_{z4}+F_{z6}>thr_{2nd,veh}).

The condition(s) relating to the lateral and vertical wheel forces may be supplemented by one or more other conditions for detection of potential rollover, as will be exemplified in the following with reference to the example vehicle 400.

Using one or more supplemental conditions may further strengthen accuracy of the detections of potential rollover. For example, is the vehicle 400 is driven over rough terrain, one of the wheels may be entirely off the ground even if there is no risk of rollover. Using only force based rollover detection might possibly trigger rollover mitigation (e.g., warning, limited speed, etc.) in some of these scenarios, while one or more supplemental conditions may hinder false detections.

In some examples, a supplemental condition for detection of potential rollover is that the roll angle α exceeds a threshold value for the roll angle. This condition aims to indicate that the vehicle, or vehicle unit, is tilting substantially. Thereby, more accurate detections of potential rollover might be achieved (e.g., avoiding false positives and/or missed detections).

For the pull unit 410, this condition may be expressed as (|αₚ|>thr_{roll,pull}). For the hauler unit 420, this condition may be expressed as (|α_{H}|>thr_{roll,haul}). For the entire vehicle 400, this condition may, for example, be expressed as (|(αₚ+α_{H})/2|>thr_{roll,veh}).

In some examples, a supplemental condition for detection of potential rollover when the vehicle comprises at least two vehicle units is that a difference between the roll angles of different vehicle units exceeds a threshold value for the difference. This condition aims to indicate that one of the vehicle units is tilting substantially more than the other vehicle unit. Thereby, more accurate detections of potential rollover might be achieved (e.g., avoiding false positives and/or missed detections).

For the vehicle 400, this condition may, for example, be expressed as (|αₚ−α_{H}|>thr_{Δroll,veh}).

In some examples, a supplemental condition for detection of potential rollover involves the derivative (with regard to the roll angle α) of the roll moment Mₓ of a vehicle unit. To this end, it is noted that roll dynamics are stable (e.g., no ongoing rollover) when

$$\frac{δ}{δα} {M}_{x} < 0 ,$$

and that roll dynamics are unstable (e.g., ongoing rollover) when

$$\frac{δ}{δα} {M}_{x} > 0 ,$$

with

$$\frac{δ}{δα} {M}_{x} = 0$$

being the inflection point. Any one or more of these expressions may be utilized for detection of potential rollover, as suitable.

For example, a possible supplemental condition for detection of potential rollover is that the derivative (with regard to the roll angle α) of the roll moment Mₓ of a vehicle unit has a negative value and the roll moment multiplied by a sign of the roll angle Mₓ sign(α) exceeds a threshold value for the roll moment. This condition aims to indicate that the roll dynamics are currently stable, but approaching instability. Thereby, more accurate detections of potential rollover might be achieved (e.g., avoiding missed detections).

For the pull unit 410, this condition may be expressed as

$$( \frac{δ}{{δα}_{P}} {M}_{xP} < 0$$

and M_{xP} sign(αₚ)>thr_{mom,pull}). For the hauler unit 420, this condition may be expressed as

$$( \frac{δ}{{δα}_{H}} {M}_{xH} < 0$$

and M_{xH} sign(α_{H})>thr_{mom,haul}).

It should be noted that any suitable combination of the example condition presented above, and/or other conditions, may be useful for rollover detection.

For example, one combined condition for detection may be expressed in the form of (F_{Y1}>F_{Y2} and F_{Z1}>F_{Z2}) and (F_{Y1}+F_{Z1}>thrₛᵤₘ) and (|a|>thrᵣₒₗₗ), where F_{Y1} represents any suitable combination of lateral forces on a first side of the vehicle, F_{Y2} represents any suitable combination of lateral forces on a second side of the vehicle, F_{z1} represents any suitable combination of vertical forces on a first side of the vehicle, F_{z2} represents any suitable combination of vertical forces on a second side of the vehicle, and a represents any suitable rollover angle metric of the vehicle.

Alternatively or additionally, one combined condition for detection may be expressed in the form of (F_{Z1}>F_{Z2}) and (F_{Y1}+F_{Z1}>thr_{sum,low,1}) and

$$( \frac{δ}{δ t} ( {F}_{Y 1} + {F}_{Z 1} ) > {thr}_{der} ) ,$$

where thr_{sum,low,1} has a lower value than thrₛᵤₘ.

Yet alternatively or additionally, one combined condition for detection may be expressed in the form of (F_{Z1}>F_{Z2}) and (F_{Y1}+F_{Z1}>thr_{sum,low,2}) and (F_{Y2}+F_{Z2}<thr_{2nd}) and—optionally—(|a|>thrᵣₒₗₗ), where thr_{sum,low,2} has a lower value than thrₛᵤₘ.

FIG. 5 illustrates a collection 500 of method steps for detecting potential rollover situations for a vehicle. The method steps of FIG. 5 are computer-implemented and may, for example, be executed by a processor device of a computer system.

According to some examples, one or more of the method steps of FIG. 5 may be implemented as part of step 120 of the method 100 described in connection to FIG. 1. Thus, one or more of the steps of FIG. 5 may be seen as sub-steps of step 120 of the method 100.

As illustrated by step 521, it is determined whether or not the vertical wheel force(s) on one (first) side of the vehicle is/are larger than the vertical wheel force(s) on the other (second) side of the vehicle. If so (Y-path out of 521), the process continues to step 522. Otherwise (N-path out of 521), it is concluded that there is no detected risk of rollover as illustrated by 528.

It may be noted that the determination of step 521 may be seen as a determination of whether there is load displacement towards either side of the vehicle, and—if so—towards which of the sides (i.e., specifying which side is to be considered as the first side for the following steps). Consequently, the N-path out of 521 may be seen as corresponding to a situation when there is no load displacement towards either side of the vehicle. In some examples, the condition in step 521 may be adjusted so that the N-path out of 521 is followed when there is no, or a very small, load displacement.

When the process continues to step 522, it is determined whether or not the lateral wheel force(s) on the first side of the vehicle is/are larger than the lateral wheel force(s) on the second side of the vehicle. If so (Y-path out of 522), the process continues to optional step 523, or directly to 529. Otherwise (N-path out of 522), it is concluded that there is no detected risk of rollover as illustrated by 528.

In optional step 523, it is determined whether or not a sum of the lateral and vertical wheel forces for the first lateral side of the vehicle exceeds a threshold value for the sum (thr; compare with thr_{sum,i} mentioned in connection with FIG. 4). If so (Y-path out of 523), the process continues to 529. Otherwise (N-path out of 523), it is concluded that there is no detected risk of rollover as illustrated by 528.

As illustrated by 529, potential rollover is detected when there is load displacement towards either (the first) side of the vehicle (step 521) and the lateral wheel force(s) on the first side is/are larger than the lateral wheel force(s) on the second side (step 522) and (optionally) the sum of the lateral and vertical wheel forces for the first lateral side exceeds the threshold value.

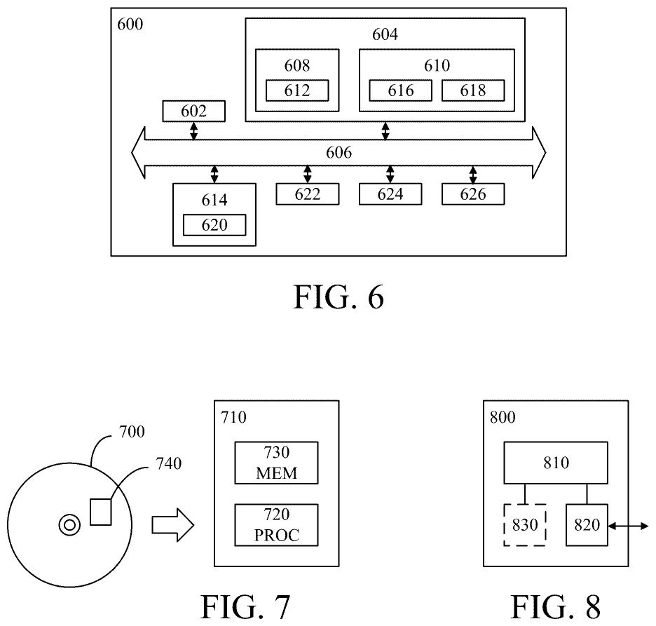

FIG. 6 is a schematic diagram of a computer system 600 for implementing examples disclosed herein. For example, the computer system 600 (or part thereof) may be comprised in the VCU 290 of FIG. 2 and/or the VCU 390 of FIG. 3. Alternatively or additionally, the computer system 600 may be configured to cause execution of (e.g., may be configured to perform) one or more steps of the method 100 of FIG. 1 and/or one or more steps of the method 500 of FIG. 5.

The computer system 600 is adapted to execute instructions from a computer-readable medium to perform these and/or any of the functions or processing described herein. The computer system 600 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system 600 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The described examples and their equivalents may be realized in software or hardware or a combination thereof. The examples may be performed by general purpose circuitry. Examples of general purpose circuitry include digital signal processors (DSP), central processing units (CPU), co-processor units, field programmable gate arrays (FPGA) and other programmable hardware. Alternatively or additionally, the examples may be performed by specialized circuitry, such as application specific integrated circuits (ASIC). The general purpose circuitry and/or the specialized circuitry may, for example, be associated with or comprised in an electronic apparatus such as a VCU.

The electronic apparatus may comprise arrangements, circuitry, and/or logic according to any of the examples described herein. Alternatively or additionally, the electronic apparatus may be configured to perform method steps according to any of the examples described herein.

According to some examples, a computer program product comprises a non-transitory computer readable medium such as, for example, a universal serial bus (USB) memory, a plug-in card, an embedded drive, or a read only memory (ROM). FIG. 7 illustrates a computer program product exemplified as a non-transitory computer-readable medium in the form of a compact disc (CD) ROM 700. The computer-readable medium has stored thereon program code 740 comprising instructions. The program code is loadable into processing circuitry (PROC; e.g., a data processing unit) 720, which may, for example, be comprised in a VCU 710. When loaded into the processing circuitry, the program code may be stored in a memory (MEM) 730 associated with, or comprised in, the processing circuitry. According to some examples, the program code may, when loaded into, and run by, the processing circuitry, cause execution of method steps according to any of the methods described herein; such as method steps discussed in connection to FIG. 1 and/or FIG. 5.

FIG. 8 schematically illustrates, in terms of a number of functional units, the components of a control unit 800 according to some examples. This control unit 800 may be comprised in the vehicle 200, 300, 400; e.g., in the form of a VCU 290, 390. Processing circuitry 810 is provided using any combination of one or more of a suitable central processing unit CPU, multiprocessor, microcontroller, digital signal processor DSP, etc., capable of executing software instructions stored in a computer program product, e.g. in the form of a storage medium 830. The processing circuitry 810 may further be provided as at least one application specific integrated circuit ASIC, or field programmable gate array FPGA.

Particularly, the processing circuitry 810 is configured to cause the control unit 800 to perform a set of operations, or steps, according to any of the methods described herein; such as method steps discussed in connection to FIG. 1 and/or FIG. 5. Consequently, there is disclosed herein a control unit 800 for controlling a heavy-duty vehicle 200, 300, 400 as described herein.

For example, the storage medium 830 may store the set of operations, and the processing circuitry 810 may be configured to retrieve the set of operations from the storage medium 830 to cause the control unit 800 to perform the set of operations. The set of operations may be provided as a set of executable instructions. Thus, the processing circuitry 810 is thereby arranged to execute method steps as herein disclosed. In particular, there is disclosed a control unit 800 for controlling an articulated vehicle 200, 300, 400 comprising a tractor unit 210, 310 and/or one or more towed vehicle units 220, 320, the control unit comprising processing circuitry 810, an interface 820 coupled to the processing circuitry 810, and a memory 830 coupled to the processing circuitry 810, wherein the memory comprises machine readable computer program instructions that, when executed by the processing circuitry, causes the control unit to perform any one or more of the method steps discussed herein.

The storage medium 830 may also comprise persistent storage, which, for example, can be any single one or combination of magnetic memory, optical memory, solid state memory or even remotely mounted memory.

The control unit 800 may further comprise an interface 820 for communications with at least one external device. As such, the interface 820 may comprise one or more transmitters and receivers, comprising analogue and digital components and a suitable number of ports for wireline or wireless communication.

The processing circuitry 810 controls the general operation of the control unit 800, e.g., by sending data and control signals to the interface 820 and the storage medium 830, by receiving data and reports from the interface 820, and by retrieving data and instructions from the storage medium 830. Other components, as well as the related functionality, of the control node are omitted in order not to obscure the concepts presented herein.

### A Non-Exhaustive List of Examples

Example 1: A computer system for detecting potential rollover situations for a vehicle comprising one or more vehicle units, the computer system comprising processing circuitry configured to acquire lateral and vertical wheel forces for one of the vehicle units, and detect potential rollover for the vehicle unit based on the lateral and vertical wheel forces as compared between first and second lateral sides of the vehicle unit.

Example 2: The computer system of Example 1, wherein the processing circuitry is configured to detect potential rollover responsive to the lateral wheel forces being larger for the first lateral side of the vehicle unit than for the second lateral side of the vehicle unit, and the vertical wheel forces being larger for the first lateral side of the vehicle unit than for the second lateral side of the vehicle unit.

Example 3: The computer system of any of Examples 1-2, wherein the processing circuitry is configured to detect potential rollover responsive to a sum of the lateral and vertical wheel forces for the first lateral side of the vehicle unit exceeding a threshold value for the sum.

Example 4: The computer system of Example 3, wherein the processing circuitry is configured to detect potential rollover responsive to a derivative—with regard to time—of the sum of the lateral and vertical wheel forces for the first lateral side of the vehicle unit exceeding a threshold value for the derivative.

Example 5: The computer system of any of Examples 1-4, wherein the processing circuitry is configured to detect potential rollover responsive to the lateral and/or vertical wheel forces for the second lateral side of the vehicle unit being less than respective threshold value(s) for the second lateral side.

Example 6: The computer system of any of Examples 1-5, wherein the processing circuitry is configured to detect potential rollover for the vehicle unit further based on a roll angle for the vehicle unit.

Example 7: The computer system of Example 6, wherein the processing circuitry is configured to detect potential rollover responsive to the roll angle exceeding a threshold value for the roll angle.

Example 8: The computer system of any of Examples 6-7, wherein the vehicle comprises at least two vehicle units, and wherein the processing circuitry is configured to detect potential rollover responsive to a difference between the roll angle and another roll angle of another one of the at least two vehicle units exceeding a threshold value for the difference.

Example 9: The computer system of any of Examples 7-8, wherein the processing circuitry is configured to detect potential rollover responsive to a derivative—with regard to the roll angle—of a roll moment of the vehicle unit having a negative value and the roll moment multiplied by a sign of the roll angle exceeding a threshold value for the roll moment.

Example 10: The computer system of any of Examples 1-9, wherein the processing circuitry is further configured to—responsive to detecting potential rollover for the vehicle unit—issue a warning for an operator of the vehicle, and/or limit a speed of the vehicle.

Example 11: A computer-implemented method for detecting potential rollover situations for a vehicle comprising one or more vehicle units, the method comprising acquiring, by a processor device of a computer system, lateral and vertical wheel forces for one of the vehicle units, and detecting, by the processor device, potential rollover for the vehicle unit based on the lateral and vertical wheel forces as compared between first and second lateral sides of the vehicle unit.

Example 12: The method of Example 11, wherein potential rollover is detected responsive to the lateral wheel forces being larger for the first lateral side of the vehicle unit than for the second lateral side of the vehicle unit, and the vertical wheel forces being larger for the first lateral side of the vehicle unit than for the second lateral side of the vehicle unit.

Example 13: The method of any of Examples 11-12, wherein potential rollover is detected responsive to a sum of the lateral and vertical wheel forces for the first lateral side of the vehicle unit exceeding a threshold value for the sum.

Example 14: The method of Example 13, wherein potential rollover is detected responsive to a derivative—with regard to time—of the sum of the lateral and vertical wheel forces for the first lateral side of the vehicle unit exceeding a threshold value for the derivative.

Example 15: The method of any of Examples 11-14, wherein potential rollover is detected responsive to the lateral and/or vertical wheel forces for the second lateral side of the vehicle unit being less than respective threshold value(s) for the second lateral side.

Example 16: The method of any of Examples 11-15, wherein detecting potential rollover for the vehicle unit is further based on a roll angle for the vehicle unit.

Example 17: The method of Example 16, wherein potential rollover is detected responsive to the roll angle exceeding a threshold value for the roll angle.

Example 18: The method of any of Examples 16-17, wherein the vehicle comprises at least two vehicle units, and potential rollover is detected responsive to a difference between the roll angle and another roll angle of another one of the at least two vehicle units exceeding a threshold value for the difference.

Example 19: The method of any of Examples 16-18, wherein potential rollover is detected responsive to a derivative—with regard to the roll angle—of a roll moment of the vehicle unit having a negative value and the roll moment multiplied by a sign of the roll angle exceeding a threshold value for the roll moment.

Example 20: The method of any of Examples 11-19, further comprising—responsive to detecting potential rollover for the vehicle unit—issuing, by the processor device, a warning for an operator of the vehicle, and/or limiting, by the processor device, a speed of the vehicle.

Example 21: A vehicle comprising the computer system of any of Examples 1-10 and/or a processor device configured to perform the method of any of Examples 11-20.

Example 22: A control system comprising one or more control units configured to perform the method of any of Examples 11-20.

Example 23: A computer program product comprising program code for performing, when executed by a processor device, the method of any of Examples 11-20.

Example 24: A non-transitory computer-readable storage medium comprising instructions, which when executed by a processor device, cause the processor device to perform the method of any of Examples 11-20.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for detecting potential rollover situations for a vehicle comprising one or more vehicle units, the computer system comprising processing circuitry configured to:
acquire lateral and vertical wheel forces for one of the vehicle units; and
detect potential rollover for the vehicle unit based on the lateral and vertical wheel forces as compared between first and second lateral sides of the vehicle unit.

2. The computer system of claim 1, wherein the processing circuitry is configured to detect potential rollover responsive to the lateral wheel forces being larger for the first lateral side of the vehicle unit than for the second lateral side of the vehicle unit, and the vertical wheel forces being larger for the first lateral side of the vehicle unit than for the second lateral side of the vehicle unit.

3. The computer system of claim 1, wherein the processing circuitry is configured to detect potential rollover responsive to a sum of the lateral and vertical wheel forces for the first lateral side of the vehicle unit exceeding a threshold value for the sum.

4. The computer system of claim 3, wherein the processing circuitry is configured to detect potential rollover responsive to a derivative with regard to time of the sum of the lateral and vertical wheel forces for the first lateral side of the vehicle unit exceeding a threshold value for the derivative.

5. The computer system of claim 1, wherein the processing circuitry is configured to detect potential rollover responsive to the lateral and/or vertical wheel forces for the second lateral side of the vehicle unit being less than respective threshold value(s) for the second lateral side.

6. The computer system of claim 1, wherein the processing circuitry is configured to detect potential rollover for the vehicle unit further based on a roll angle for the vehicle unit.

7. A computer-implemented method for detecting potential rollover situations for a vehicle comprising one or more vehicle units, the method comprising:
acquiring, by a processor device of a computer system, lateral and vertical wheel forces for one of the vehicle units; and
detecting, by the processor device, potential rollover for the vehicle unit based on the lateral and vertical wheel forces as compared between first and second lateral sides of the vehicle unit.

8. The method of claim 7, wherein potential rollover is detected responsive to the lateral wheel forces being larger for the first lateral side of the vehicle unit than for the second lateral side of the vehicle unit, and the vertical wheel forces being larger for the first lateral side of the vehicle unit than for the second lateral side of the vehicle unit.

9. The method of claim 7, wherein potential rollover is detected responsive to a sum of the lateral and vertical wheel forces for the first lateral side of the vehicle unit exceeding a threshold value for the sum.

10. The method of claim 9, wherein potential rollover is detected responsive to a derivative with regard to time of the sum of the lateral and vertical wheel forces for the first lateral side of the vehicle unit exceeding a threshold value for the derivative.

11. The method of claim 7, wherein potential rollover is detected responsive to the lateral and/or vertical wheel forces for the second lateral side of the vehicle unit being less than respective threshold value(s) for the second lateral side.

12. The method of claim 7, wherein detecting potential rollover for the vehicle unit is further based on a roll angle for the vehicle unit.

13. The method of claim 12, wherein potential rollover is detected responsive to the roll angle exceeding a threshold value for the roll angle.

14. The method of claim 12, wherein the vehicle comprises at least two vehicle units, and potential rollover is detected responsive to a difference between the roll angle and another roll angle of another one of the at least two vehicle units exceeding a threshold value for the difference.

15. The method of claim 12, wherein potential rollover is detected responsive to a derivative with regard to the roll angle of a roll moment of the vehicle unit having a negative value and the roll moment multiplied by a sign of the roll angle exceeding a threshold value for the roll moment.

16. The method of claim 7, further comprising, responsive to detecting potential rollover for the vehicle unit, issuing, by the processor device, a warning for an operator of the vehicle, and/or limiting, by the processor device, a speed of the vehicle.

17. A vehicle comprising one or more vehicle units, and comprising a processor device configured to perform the method of any of claim 7.

18. A control system comprising one or more control units configured to perform the method of claim 7.

19. A computer program product comprising program code for performing, when executed by a processor device, the method of claim 7.

20. A non-transitory computer-readable storage medium comprising instructions, which when executed by a processor device, cause the processor device to perform the method of claim 7.
